(19) United States
(12) Patent Application Publication
(10) Pub. No.: US 2024/0242250 A1
(43) Pub. Date: Jul. 18, 2024

(54) SYSTEM AND METHODS FOR CREATING A DISTRIBUTION CAMPAIGN AND ASSOCIATED DIGITAL CONTENT

(71) Applicant: United States Postal Service, Washington, DC (US)

(72) Inventors: Fernando Mello, Washington, DC (US); Robert E. Dixon, JR., Haymarket, VA (US)

(21) Appl. No.: 18/410,730

(22) Filed: Jan. 11, 2024

Related U.S. Application Data
(60) Provisional application No. 63/479,860, filed on Jan. 13, 2023.

(51) Int. Cl. G06Q 30/0241

(52) U.S. Cl. CPC G06Q 30/0276; G06Q 30/0277

(57) ABSTRACT

Systems and methods for creating a distribution campaign and delivering a digital content associated with the distribution campaign are disclosed herein. In some embodiments, an imaging device may capture an image of one or more campaign distribution items. A user interface in communication with the image capture device may receive a request to generate a distribution campaign, receive target addresses, and receive digital content associated with the distribution campaign. The user interface may generate an intelligent campaign barcode for each of the target addresses and a label for each of the target addresses to be affixed to one or more campaign distribution items. The user interface may receive the image of a campaign distribution item, detect the intelligent campaign barcode on the label affixed to the campaign distribution item; and deliver the digital content to an email address associated with the target address based on the intelligent campaign barcode.

### CROSS-REFERENCE TO RELATED APPLICATIONS

This application claims the benefit of priority to U.S. Provisional Application Ser. No. 63/479,860, filed Jan. 13, 2023, entitled “SYSTEM AND METHODS FOR CREATING A DISTRIBUTION CAMPAIGN AND ASSOCIATED DIGITAL CONTENT,” which is incorporated by reference herein in its entirety.

### BACKGROUND

Recent advancements in the field of digital communications have resulted in a wide variety of alternative paths by which a user can receive information. In particular, advancements in electronic mail services and instant messaging services have diverted traffic away from traditional physical mail channels, as instantaneous communications have permanently changed the perceptions and behaviors of users with respect to communication. In 2010, broadband Internet penetration reached 80% and wireless web penetration reached 96% penetration. With the Internet's accessibility at such heights, users are increasingly turning to its convenience to manage all aspects of communications, financial transactions, and commerce.

Because of the increased importance of electronic communications, and because physical mail plays an important role, it is desirable to enhance physical mail by providing novel digital features to the physical mail experience.

### BRIEF DESCRIPTION OF THE DRAWINGS

FIG. 1 shows, in block diagram form, an example system for a distribution campaign and delivering digital content associated with the distribution campaign;

FIG. 2 is a flow diagram depicting an exemplary embodiment for creation of a distribution campaign and delivery of digital content;

FIG. 3 is a flow diagram illustrating an exemplary embodiment for creation of a distribution campaign and delivery of customized digital content;

FIG. 4A is an example user interface providing a delivery notification that includes a delivery icon and a digital payload;

FIG. 4B is an example user interface providing digital content;

FIG. 5A depicts an example user interface for selecting a delivery icon template;

FIG. 5B is an example user interface for customizing the selected delivery icon template;

FIG. 5C is an example user interface providing a delivery notification email that includes the customized delivery icon;

FIG. 6A illustrates an example user interface for selecting a digital coupon template;

FIG. 6B is an example user interface for customizing the selected digital coupon template;

FIG. 6C is an example user interface for providing a delivery notification email that includes an image of the item and a delivery icon; and

FIG. 6D illustrates an example user interface for providing the delivery icon and the customized digital coupon.

### SUMMARY

In one aspect described herein, a system for creating a distribution campaign and delivering a digital content associated with the distribution campaign may comprise an imaging device configured to capture an image of one or more campaign items and one or more processors in communication with the imaging device. The one or more processors may be configured to receive a request to generate the distribution campaign; receive one or more target addresses; receive a digital content associated with the distribution campaign; generate an intelligent campaign barcode associated with the distribution campaign for each of the one or more target addresses; cause generation of a physical indicator for each of the one or more target addresses to be affixed to the one or more campaign distribution items, wherein the physical indicator includes the intelligent campaign barcode associated with the distribution campaign; receive the image of the one or more campaign distribution items; detect the intelligent campaign barcode on the physical indicator affixed to the one or more campaign distribution items; and deliver the digital content to an email address associated with the one or more target addresses based on the intelligent campaign barcode.

In some embodiments, the digital content may comprise a delivery icon and a digital payload accessible through the delivery icon.

In some embodiments the delivery icon may be one of: an image, an animation, or a video.

In some embodiments, the digital payload may be one of: a text greeting, an image file, a video file, a sound, a digital coupon, a hyperlink.

In some embodiments, the one or more processors may be further configured to provide the delivery icon and the digital payload for download.

In some embodiments, the system may further include item processing equipment The item processing equipment may be configured to be placed in communication with the one or more processors and affix the generated physical indicator to the one or more campaign distribution items.

In some embodiments, the one or more processors may be further configured to receive a request to generate the delivery icon associated with the distribution campaign; display a library of digital content; receive a selection of digital content from the library of digital content; and provide the selected digital content as the delivery icon associated with the distribution campaign.

In some embodiments, the library of digital content may include one or more of: a static image, an animation, or a video.

In some embodiments, the digital content in the digital content library may conform with digital content parameters.

In some embodiments, the one or more processors may be further configured to provide the selected digital content in an editing module; receive at least one customization input via the editing module, wherein the at least one customization input changes the appearance of the selected digital content; apply the customization input to the selected digital content; and provide the selected digital content as the delivery icon associated with the distribution campaign.

In some embodiments, the one or more processors may be further configured to: receive a request to generate a digital coupon; display a library of digital coupon templates; receive a selection of an electronic coupon template; and provide the selected coupon template as the digital payload associated with the distribution campaign.

In some embodiments, the one or more processors may be further configured to provide the selected coupon template in an editing module; receive at least one customization input via the editing module, wherein the at least one customization input changes the appearance of the selected coupon template; apply the customization input to the selected coupon template; and provide the selected coupon template as the delivery icon associated with the distribution campaign.

In some embodiments, the electronic coupon may include a barcode.

In some embodiments, the request to generate the distribution campaign may comprise a distribution campaign theme.

In some embodiments, the one or more processors may be further configured to generate a label icon on the physical indicator based on the distribution campaign theme.

In some embodiments, the one or more processors may be further configured to receive a request to include the label icon on the physical indicator; and generate the label icon on the physical indicator.

In some embodiments, the one or more processors may be further configured to receive a label icon; and generate the label icon on the physical indicator.

In some embodiments, the one or more processors may be further configured to provide the one or more target addresses to a mailing API; receive the list of verified mailing addresses from the mailing API; and generate the physical indicator for each of the one or more target addresses using the list of verified mailing addresses. The mailing API may be configured to identify a verified mailing address for each of the one or more target addresses and generate a list of verified mailing addresses.

In some embodiments, the one or more processors may be further configured to display a prompt to replace the one or more target addresses with the list of verified mailing addresses; receive a confirmation to replace the one or more target addresses with the list of verified mailing addresses; and generate the physical indicator for each of the one or more target addresses using the list of verified mailing addresses.

In some embodiments, the one or more processors may be further configured to identify a verified mailing address for each of the one or more target addresses; generate a list of verified mailing addresses; and generate the physical indicator for each of the one or more target addresses using the list of verified mailing addresses.

In some embodiments, the one or more processors may be further configured to display a prompt to replace the one or more target addresses with the list of verified mailing addresses; receive a confirmation to replace the one or more target addresses with the list of verified mailing addresses; and generate the physical indicator for each of the one or more target addresses using the list of verified mailing addresses.

In some embodiments, the one or more processors may be further configured to receive the one or more target address in a CSV file format.

In some embodiments, the one or more processors may be further configured to receive campaign sender information, wherein the campaign sender information includes a sender name and a sender address.

In some embodiments, the system may further comprise a printer in communication with the one or more processors. The printer may be configured to print the physical indicator for each of the one or more target addresses.

In some embodiments, the one or more processors may be further configured to provide a delivery status of the distribution campaign to a sender. The delivery status may indicate whether the one or more campaign items are: in transit, out for delivery, or delivered.

In some embodiments, the delivery status of the distribution campaign indicates a location of each of the one or more campaign items.

In some embodiments, the one or more processors may be further configured to store the distribution campaign, the delivery icon, the digital payload, the one or more target addresses, and the intelligent campaign barcode.

In some embodiments, the one or more processors may be further configured to display a previous campaign dashboard. The previous campaign dashboard may include a campaign icon representing the distribution campaign.

In some embodiments, the one or more processors may be further configured to receive a selection of the campaign icon in the previous campaign dashboard; provide the distribution campaign, the delivery icon, the digital payload, the one or more target addresses for editing; receive an update to one or more of: the distribution campaign, the delivery icon, the digital payload, the one or more target addresses; and generate the physical indicator for each of the one or more target addresses based on the update.

### DETAILED DESCRIPTION

In the following detailed description, reference is made to the accompanying drawings, which form a part thereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

The present disclosure relates to systems and methods for creation of a distribution campaign and customization and delivery of digital content along with physical campaign items that are delivered within a distribution network such as the United States Postal Service (USPS).

A distribution network may comprise multiple levels. For example, a distribution network may comprise regional distribution facilities, hubs, and unit delivery facilities, or any other desired level. A nationwide distribution network, for example, may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the USPS, the unit delivery facility may be associated with a ZIP Code. The unit delivery facility receives items from local senders, and from hub level facilities or regional distribution facilities. The unit delivery facility also sorts and stages the items intended for delivery to destinations within the unit delivery facility's coverage area.

Facilities at various levels of the distribution network may be equipped with sorting systems, item processing equipment, and/or an imaging system to image items as the items make their way through the distribution network. The imaging system may include an imaging device. As used herein, the term imaging device may refer to a camera, a barcode scanner, or the like. In some embodiments, the imaging system may include a plurality of handheld scanning devices that may be used to image items at different levels of the distribution network. For example, a handheld scanning device may scan at item at a pick-up or drop-off location. The imaging system may include other components such as one or more processors and a memory configured to store computer-instructions. These terms are exemplary only, and the scope of the present disclosure is not limited thereto. Other means for tracking and identifying items may be substituted.

As used herein, the term item may refer to an individual article, object, agglomeration of articles, or container having more than one article within, in a distribution system. The item may be a letter, magazine, flat, luggage, package, box, physical mailpiece, or any other item of inventory which is transported or delivered in a distribution system or network. The term item may also refer to a unit or object which is configured to hold one or more individual items, such as a container which holds multiple letters, magazines, boxes, etc. The term item may also include any object, container, storage area, rack, tray, truck, train car, airplane, or other similar device into which items or articles may be inserted and subsequently transported, as are commonly used in distribution systems and networks.

In order to provide the capabilities described herein, tracking data, including real-time tracking data can be stored. In a distribution network with many items, the storage capability must be large in order to receive, store, and provide access to the stored tracking data. In some embodiments, the system includes a central data storage repository in communication with a powerful analytical engine with real-time processing capabilities.

The terms destination address or delivery point are used to describe embodiments of the present development. As used herein, the destination address or delivery point can refer to the place to which an item, such as a physical distribution item is intended to be delivered, such as an address, geodetic coordinates, or other coordinate or system indicating a specific geographic location to which an item is to be delivered. These terms are exemplary only, and the scope of the present disclosure is not limited to a certain type of target address or delivery point. For example, a target address or delivery point may be a single-family home, a business address, a mailbox, a front porch, a post office box (“P.O. Box”), or GPS coordinates.

The term digital content and other terms are used to describe embodiments of the present development. As used herein, digital content can refer to digital coupons, graphics, videos, emails, webpages, hyperlinks, text messages, instant messages, social media messages, text, augmented reality interfaces, and the like. These terms are exemplary only, and the scope of the present disclosure is not limited thereto.

The term delivery icon and other terms are used to describe embodiments of the present development. As used herein, delivery icon can refer to an image, animation, or video that may be included in a delivery notification indicating a campaign item, which can be a physical distribution item, will be delivered to a target address. A delivery icon may also be a logo, one or more words, or a combination thereof. These terms are exemplary only, and the scope of the present disclosure is not limited thereto.

The term digital payload and other terms are used to describe embodiments of the present development. As used herein, digital payload refers to digital content that is to be delivered along with items as part of a distribution campaign. The digital payload may be any form of digital content including digital coupons, graphics, videos, emails, webpages, hyperlinks, text messages, instant messages, social media messages, text, augmented reality interfaces, and the like. These terms are exemplary only, and the scope of the present disclosure is not limited thereto.

The term distribution campaign and other terms are used to describe embodiments of the present development. As used herein, a distribution campaign can refer to an association of one or more items with a digital content and one or more target addresses. These terms are exemplary only, and the scope of the present disclosure is not limited thereto.

The term user interface (“UI”) is used to describe embodiments of the present invention. As used herein, user interface can refer to command line interfaces, graphical user interfaces, menu driven user interfaces, form-based user interfaces, natural language user interfaces, or the like. These terms are exemplary only, and the scope of the disclosure is not limited thereto.

The terms intelligent campaign barcode and campaign barcode are used to describes embodiments of the present invention. As used herein, intelligent campaign barcode and campaign barcode can refer to a computer-readable code. Linear barcodes and matrix barcodes are described herein, but the disclosed systems and methods may also utilize alphanumeric codes, binary codes, etc. These terms are exemplary only, and the scope of the disclosure is not limited thereto.

Although the disclosure may refer to a sender or recipient of an item as a person, the sender or recipient of an item may be a person, business, partnership, or any other entity capable of receiving an item through a distribution network. These terms are exemplary only, and the scope of the disclosure is not limited thereto.

The embodiments disclosed herein are directed toward a streamlined, automatic creation of a distribution campaign that improves delivery speeds within the distribution network and increases the efficiency and speed of item sorting machinery. By automating the creation of a distribution campaign, campaign barcodes, and labels attached to items, the present invention inherently improves the efficiency and speed of a distribution network. Campaign items are more easily identified by sorting equipment and placed on a faster route to their destination. Furthermore, processing load within the distribution network is decreased by providing a more efficient method of identifying and processing a particular campaign item.

Additionally, the embodiments disclosed herein enable unsophisticated parties to automatically generate a distribution campaign, which traditionally has been a high- cost, manual process that precludes unsophisticated parties from creating distribution campaigns. By avoiding theses costs, the embodiments disclosed herein enable more customers to employ the technologies described herein. As more customers employ distribution campaigns, sorting and routing equipment within the distribution network become even faster and more efficient because they can process more items in a smaller amount of time. When combined with prioritized routing and delivery, the present invention greatly increases the speed with which campaign items are delivered.

For example, a sender may want to send out their save the date cards for their wedding to friends and family. In addition to the physical cards, the sender may also want to include an engagement photo album to be delivered along with the card. The sender may login into a user interface of the distribution network and create a distribution campaign. Using the interface, the sender may enter or upload the addresses for their friends and family to the user interface. The sender may create and customize a delivery icon that conforms with established, predetermined formatting parameters. The sender may then upload the engagement photo album to the user interface. Once the sender has entered the information, the user interface may automatically create an intelligent campaign barcode for the save the date campaign. The user interface may also automatically generate labels, either electronically, physically, or both, for each of the save the date cards. The labels include, among other things, the intelligent campaign barcode, which may identify a target address and a campaign identifier. The sender may then attach the labels to each card and deposit the cards in a receptacle to be picked up by the distribution network.

After the cards enter the distribution network, they are scanned by the imaging system or the item sorting equipment. As mentioned above, the cards are more easily identified by the imaging system and more quickly routed by sorting equipment because of the automatically generated campaign barcode and label. The sorting equipment sets the cards apart for faster delivery along the most efficient route possible based on the label, resulting in the cards being delivered sooner. Because of the label, the sorting equipment can perform these actions faster and more efficiently, thereby increasing the volume of items that can be processed in the same amount of time and increasing the overall efficiency of the distribution network. During processing, a item processing server may determine that one of the cards has reached a unit delivery facility within the distribution network and is going out for delivery. The server may indicate to the user interface that the card is out for delivery and send an image of the cards to the user interface.

The user interface, in turn, may deliver the image of the card and the delivery icon to a recipient in a digital delivery notification. For example, the user interface may send a digital delivery notification to an email address associated with the target address on the card. A recipient may open the email, click on the delivery icon, and log into a personalized version of the user interface that is associated with the recipient. As discussed below, the user interface may provide different displays, modules, distribution campaign information, or information associated with campaign items based on whether a sender or recipient is accessing or interacting with the user interface. After the recipient logs in, the user interface provides the engagement photo album to the recipient.

The user interface may be further configured to provide campaign data to the sender who created the distribution campaign. For example, the user interface may provide a delivery status, interactions with the delivery icon and digital payload, or recipient reactions or responses. The user interface may also store the distribution campaign and associated information such as the delivery icon, the digital payload, the list of target addresses, the campaign barcode, and other distribution campaign information on a dashboard. Later, when the sender wants to send out their wedding invitations, they may create a new campaign or select the stored campaign and make changes, such as substituting the engagement photo album with a hyperlink to an RSVP form. The user interface may automatically generate new labels and provide them to the sender to attach to the wedding invitations. The user interface may also automatically generate a new or updated intelligent campaign barcode.

In some embodiments, the user interface may provide labels for the updated campaign based on recipients who interacted with the original campaign. For example, the sender may only wish to send wedding invitations to those recipients who viewed the engagement photo album. After the labels have been automatically generated by the user interface, the sender may print new labels, attach them to the wedding invitations, and send the invitations through the distribution network. Once an invitation has reached a unit delivery facility and is ready to be delivered, the user interface may receive an image of the invitation from the server and send a delivery notification to the email address associated with the target address on the invitation. When the recipient selects a delivery icon within the notification, the user interface may provide the link to the RSVP form instead of, or in addition to, the photo album.

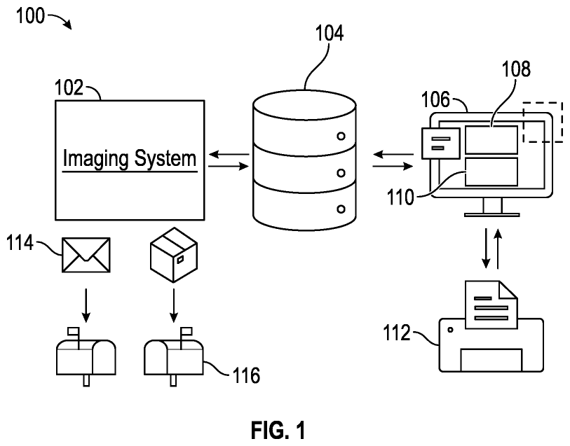

FIG. 1 depicts an example system 100 for creation of a distribution campaign and delivery of items and digital content to recipients. The system 100 is a part of a distribution network and includes an imaging system 102, a server 104, and a user interface 106. The imaging system 102 comprises an imaging device such as a camera, a scanner, a barcode scanner, or the like. The imaging system 102 also includes a memory configured to store computer-executable instructions and one or more processors configured to execute the instructions. According to some embodiments, the imaging system 102 may comprise an alternative means of detecting and identifying items such as an RFID system. In such embodiments, the imaging system 102 may comprise an RFID reader and one or more passive RFID labels affixed to the campaign items. In some embodiments, the imaging system 102 may be a component of item sorting equipment. The imaging system 102 may be placed in electronic communication with the item sorting equipment. For example, the imaging system 102 and the item sorting equipment may both be controlled the memory and the one or more processors of the imaging system.

The server 104 may be a general purpose or special purpose computing system environment or system. Computing systems include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. The server 104 may comprise a memory configured to store computer- executable instructions and one or more processors configured to execute instructions. The memory may also store distribution campaign information like target addresses, delivery icons, digital payloads, recipient information, sender information, intelligent barcodes, a campaign identifier, such as a campaign number, or the like. Furthermore, the memory may store formatting parameters, or rules, for digital content delivered as part of a distribution campaign, delivery rules or preferences for recipients.

The user interface 106 may be one of a command line interface, a graphical user interface, a menu driven user interface, a form-based user interface, a natural language user interface, or the like. The user interface 106 may also be a combination of two or more types of user interfaces. In some embodiments, the user interface 106 may include one or more modules configured for a particular purpose, such as an editing module 108 or a data entry module 110. The user interface 106 may be executed on a remote computing device or provided to the computing device by the server 104. For example, the user interface 106 may be executed within a local device application or accessed via an internet browser. In some embodiments, the user interface 106 may be executed on a personal desktop computer, a laptop, or a smartphone. For example, a distribution network might provide the user interface 106 as part of a mobile app that is executed on a smartphone. In some embodiments, the server 104 may execute a user interface API. The user interface API may perform one or more of the functions of the user interface 106. For example, the user interface API may receive campaign information enter through a mobile app or via a desktop browser and/or create a distribution campaign based on the campaign information. As will be appreciated by one of skill in the art, the various functionalities of the user interface 106 described herein may be performed by a first remote computing device (e.g., a smart phone, desktop computer, etc.), the server 104 disposed within a distribution network, and/or a second remote computing device (e.g., a second sever) disposed outside of the distribution network according to some embodiments.

The user interface 106 may provide a display or information based on a set of permissions associated with a particular user. The user interface 106 may provide different displays or information regarding the distribution campaign based on whether a particular user is acting as a sender or a recipient of a distribution campaign. For example, when the user interface 106 delivers the digital content, the user interface 106 may only provide the digital content, an image of the item, and/or an estimated delivery time or date. Conversely, the sender of a distribution campaign may log into the user interface 106 and view location information, delivery status, campaign interaction metrics, or similar information regarding the distribution campaign in addition to the digital content and images of campaign items. The displays and information provided by the user interface 106 may be determined by a set of permissions associated with a particular user.

The system 100 includes a printer 112 to create the intelligent campaign labels affixed to the campaign items. The printer 112 may be a laser printer, a solid ink printer, an LED printer, an inkjet printer, a dot matrix printer, or the like. In some embodiments, the printer 112 may print the intelligent campaign label directly on the items. The printer 112 may also print the campaign items according to some embodiments. The term printer is not intended to limit the scope of this disclosure. Different methods of label creation may be employed in various embodiments described herein. In some embodiments, the item processing equipment comprises a printer or printing device. In some embodiments, the item processing equipment affixes the physical indicator, such as a label, to the campaign items as they are sorted or processed in the item processing equipment. In some embodiments, physical identifiers, such as campaign labels, can be placed upon the campaign by a sender of the items. For example, generated indicators, such as labels, can be sent to a sender of the items or to the user requesting the labels. In some embodiments, the item processing equipment can recognize and item as belonging to a campaign when the item is processed, and the item processing equipment can affix the label to the campaign items.

The imaging system 102, the server 104, and the user interface 106 may be electronically connected. The imaging system 102 and server 104 may be at the same location, and, according to some embodiments, may be housed as a single device. In some embodiments the imaging system 102 and server 104 may be remotely connected and configured to wirelessly exchange data. As discussed above, the user interface 106 may be executed on a remote computing device which may be in communication with the imaging system 102, server 104, or both the imaging system 102 and the server 104. The remote computing device may be a mobile phone, personal computer, kiosk, smart watch, or the like. In some embodiments, the remote computing device may execute the user interface 106. In some embodiments, the user interface 106 may be executed by the server 104 and delivered to the remote computing device. Additionally, the printer 112 may be placed in electronic communication with the imaging system 102, the server 104, and/or the user interface 106 via a wired connection, a local network, or the internet.

The imaging system 102 may be configured to capture an image of items 114 within a distribution network, e.g. during transport from a sender to one or more target addresses 116. The imaging system 102 may transmit the image of the campaign items 114 to the server 104 and/or the user interface 106. The imaging system 102 may be located at any point in the distribution network including a regional distribution facility, a hub facility, and a unit distribution facility. In some embodiments, the imaging system 102 may be a part of item processing equipment, such as a sorter or intake apparatus. The imaging system 102 may capture an image of a variety of items including letters, parcels, and packages that are passing through the distribution network. In some embodiments, the imaging system 102 may process the captured image and produce image data concerning the campaign items 114. Image data may be data associated with the item or metadata associated with the imaging of the item. For example, image data may include recipient or sender information, a campaign identifier, a type of item, a status of the item (damaged/undamaged), a location of the item, a time in transit, an estimated delivery date or time, a time the image was taken, metadata associated with the imaging system 102, or the like. The imaging system 102 may transmit the image data to the server 104 or the user interface 106. In some embodiments, the imaging system 102 may store images and image data, and upon request from the server 104 or user interface 106, transmit the image or image data to the server 104 and/or the user interface 106.

The server 104 may communicate with the imaging system 102 and the user interface 106. In some embodiments, the server 104 may execute one or more application programming interfaces (APIs). For example, the server 104 may execute a distribution campaign API that automatically generates a distribution campaign based on inputs received via a user interface. The server 104 may also execute a target address API that validates an entered address, provides a corrected address, and/or prompts a user to re-enter an address. According to some embodiments, the server 104 may execute a user interface API that receives user inputs and provides information regarding the creation of a distribution campaign. The user interface API executed by the server 104 may perform one or more of the functionalities of the user interface 106 described below on the server 104. For example, in some embodiments, backend operations of the user interface such as the generation of the intelligent campaign barcode may be performed by the user interface API executed by the server 104.

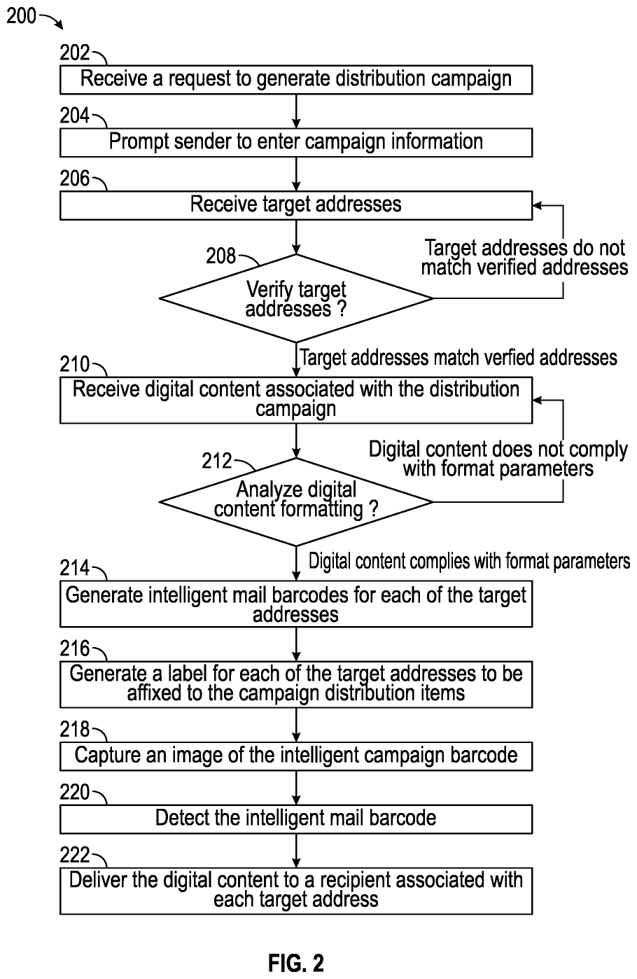

FIG. 2 is a flow diagram depicting an exemplary process 200 performed by a user interface such as the user interface 106. The user interface 106 can be similar to those embodiments described elsewhere herein.

Process 200 begins with step 202 where the user interface 106 receives a request to generate a distribution campaign. The user interface 106 may receive various user inputs in the course the creation of a distribution campaign and distribution of digital content associated with the distribution campaign. The inputs received by the user interface 106 may be from a creator or sender of the distribution campaign and may take different forms based on the type of user interface employed in a particular embodiment. For example, the user interface 106 may be a GUI interface may receive a touch input, a speech input, and/or a keyboard text input from the creator. The user interface 106 may provide a create campaign element, such as a button, that generates the request when a creator or sender clicks on the element.

In some embodiments, the user interface 106 may receive a voice input to initiate the creation of the distribution campaign, e.g. a voice command to a smart assistant. In some embodiments, the user interface 106 may prompt the sender to create or log in to an account. For example, in response to receiving the request to generate a distribution campaign, the user interface 106 may generate a login page and prompt the sender to sign in or create an account before creating a distribution campaign.

The process 200 moves to step 204 where, in response to receiving the request, the user interface 106 prompts the sender to enter campaign information such as one or more target addresses, digital content to be associated with the campaign, and/or the sender's information. In some embodiments, the user interface 106 may display one or more modules for the sender to enter or upload distribution campaign information.

The process 200 moves to step 206 where the user interface 106 receives one or more target addresses from the sender. The user interface 106 may provide a module for the sender to enter the target addresses manually. For example, the sender may enter each target address using a touch input, e.g. a virtual keyboard, and/or physical keyboard. In another example, the sender may enter the target address(es) using voice input(s). In some embodiments, the sender may upload the target addresses to the user interface 106. The sender may upload an address list or upload each address one at a time or in groups.

The user interface 106 may receive the addresses via a user input as and/or in various file formats such as comma-separated values (CSV), text (TXT), or document (DOC or DOCX). In some embodiments, the user interface 106 may be configured to receive one or more image files and detect a target address from the image. For example, a creator sending out a “thank you” themed campaign could take a picture of the return address on each card they received, and the user interface 106 may detect the addresses and create a target address list based on the uploaded images. The user interface 106 may detect the addresses using an optical character recognition (OCR) program or any other image recognition software. In some embodiments, the user interface 106 may store the detected addresses. The user interface 106 may provide a list of the detected addresses to the sender, and the user may select one or more of the stored addresses as target addresses.

In some embodiments, the sender may also be a recipient, and the user interface 106 may store the return addresses for mail received by the sender. The user interface 106 may provide these stored addresses to the sender, and the sender may select one or more return addresses to be used as target addresses. For example, the sender may be sending a thank you card campaign after receiving birthday cards from friends and family. As the sender receives the birthday cards, the user interface 106 may automatically detect and store the return addresses and the name of the sender of the birthday card. When the sender creates the thank you card campaign, the user interface 106 may provide the return addresses and the names to the sender. The sender can select the return addresses as target addresses for the thank you card campaign, expediting the campaign creation process.

The process 200 moves to step 208 where the user interface 106 verifies the one or more target addresses. The user interface 106 may verify the target addresses by comparing the target addresses with a list of verified mailing addresses. If the user interface 106 determines a target address does not match a verified mailing address, the user interface 106 may notify the sender. The user interface 106 may prompt the sender to re-enter the address and return to step 206 in the process 200. In some embodiments, the user interface 106 may determine that a target address corresponds with a verified mailing address but contains an error. The user interface 106 may prompt the sender to replace the target address with the corresponding verified mailing address. In some embodiments, the user interface 106 may automatically replace the erroneous target address with the verified mailing address.

In some embodiments, the user interface 106 transmits the target addresses to a mailing API executed by a server, such as the server 104 in FIG. 1. In response, the mailing API may return a list of verified mail addresses or a list of target addresses that contain an error. In some embodiments, the mailing API may identify that a target address contains an error but corresponds with a verified mailing address. The mailing API may automatically replace the target address(es) with the verified mailing address and return a list of verified mailing addresses to the user interface 106.

The process 200 moves to step 210 where the user interface 106 receives digital content that the sender wishes to be associated with the distribution campaign. The digital content may include a delivery icon and a digital payload. The delivery icon can be an image, an animation, a video, or the like. The digital payload can be a text greeting, an image file, a video file, a sound, a digital coupon, a hyperlink, or the like. The digital payload can be a digital coupon, graphic, video, email, webpage, hyperlink, text message, instant message, social media message, text, augmented reality interface, and the like. In some embodiments, the user interface 106 may provide a module for uploading the digital content, such as an editing module or an independent upload module. The user interface 106 may provide separate modules for uploading the delivery icon and the digital payload.

The process 200 moves to step 212 where the user interface 106 analyzes the digital content to ensure the digital content conforms with digital content format parameters. The format parameters may include a file size requirement, a dimensions requirement, and a file format requirement, which may be changed from time to time. For example, the file size requirement may require the digital content to be 200 kB or less. The dimensions requirement may be 300×200 pixels or 210×140 pixels. The file format requirement may demand that the digital content be in a particular image format and/or in a specific color mode, such as a JPEG image in an RGB color mode. In some embodiments, the user interface 106 may detect that the digital content uploaded by the sender does not conform with the format parameters. In response, the user interface 106 may prompt the user to reupload the digital content and return to step 210 of the process 200. In some embodiments, the user interface 106 may automatically reformat the digital content to comply with parameters and provide the reformatted digital content to the sender for approval.

The process 200 moves to step 214 where the user interface 106 automatically generates a computer-readable code for each of the target addresses. The computer-readable code may be a linear barcode or a matrix barcode. The intelligent barcode may encode information about the target address such as the street, house number, and 9-digit Zip Code of a target address. The intelligent campaign barcode may also encode distribution campaign information such as a campaign identification number, a sender identifier, or delivery notification information. Delivery notification information may include a notification method preference or a notification frequency. For example, a recipient may prefer to receive a notification email or a push notification through a mobile app. Other recipients may elect to receive updates about the location and projected delivery date of an item before the item is out for delivery. For example, a recipient may elect to receive notifications from the user interface 106 when the imaging system 102 first captures the item as the \ item enters the distribution network.

The campaign barcode may be unique to the campaign and/or the sender and may be created automatically after the user interface 106 receives the request to generate the distribution campaign. In some embodiments, the campaign barcode is unique for each target address and has a common campaign identifier. In some embodiments, there is a common code for each item in the distribution campaign, and the computer-readable code does not include the target address. For example, the campaign barcode may encode a target address and campaign information such that each barcode is unique. In other instances, the campaign barcode may only encode campaign information such that each barcode within the distribution campaign is the same.

In some embodiments, the campaign barcode may enable tracking of the campaign items as they progress through the distribution network. Accordingly, the user interface 106 may provide tracking updates to the sender or a recipient as the campaign items pass through the distribution network. For example, each time the imaging system 102 captures an image of a campaign item, the user interface 106 may provide an updated location of the item to the sender and/or the recipient.

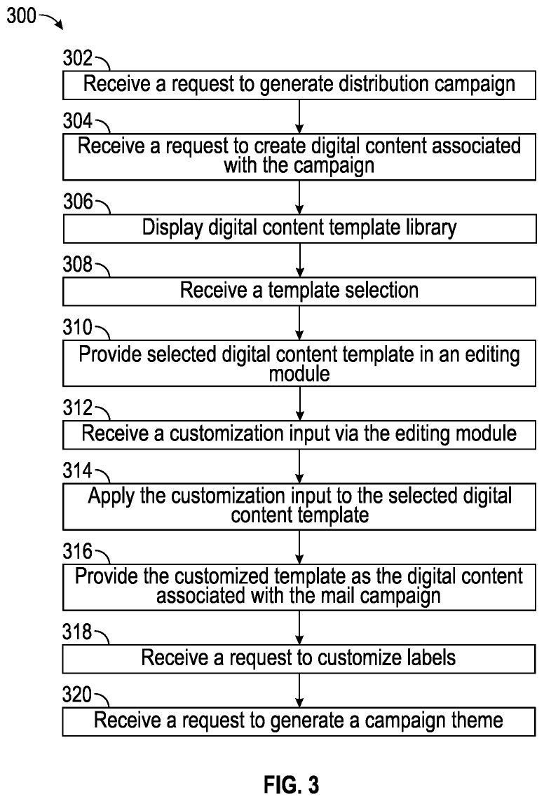

The process 200 moves to step 216 where the user interface 106 automatically generates a label for each of the target addresses. In some embodiments, the user interface 106 may automatically generate the labels for each of the target addresses and instruct the printer 112 to begin printing the labels. The label may include the target address and the intelligent campaign barcode that corresponds to the target address. The user interface 106 may generate the label for each target address in a printable format such as a PDF and automatically transmit the labels to the printer 112. In some embodiments, the user interface 106 may prompt the user to enter an item type and generate the label for each target addressed based on the type of campaign item entered by the sender. For example, the user interface 106 may create a PDF that can be printed on adhesive label paper and affixed to a package. In some embodiments, the user interface 106 may create a document for printing the labels directly on an envelope or parcel. The label may automatically be printed directly onto the one or more campaign items. Once the labels for each target address have been generated by the user interface 106, the sender may print out the labels, affix them to the campaign items, and provide the items to a distribution network, such as the United States Postal Service. In some embodiments, the label may be customized and may include a label image as discussed below in conjunction with FIG. 3.

Advantageously, the automatic creation of the campaign barcode and the labels significantly reduces financial and physical costs to the sender. Moreover, the methods and systems disclosed herein reduce the number of inputs and submissions necessary to create a distribution campaign, thereby reducing processor load, increasing memory availability of the server 104 or any device executing the user interface 106 and allowing for a more efficient distribution of resources within a distribution network. Further, by removing the barrier of entry, the automatic generation of campaign barcodes and labels increases the percentage of items within the distribution network that employ campaign barcodes, which allows for more efficient delivery, sorting, and tracking of item. Imaging and sorting equipment can more readily identify, sort, and deliver items which results in the items moving through the distribution network faster and more efficiently.

The process moves to step 218 where the campaign items are processed by a system 100 within the distribution network that includes the imaging system 102, the server 104, and the user interface 106. As the campaign items travel through the distribution network, the imaging system 102 captures an image of the campaign items and transmits the image to the server 104. The imaging system 102 may transmit the photo or scan of the campaign item to the server 104, and the server 104 may detect the intelligent campaign barcode on the item. In some embodiments the imaging system 102 may be a part of sorting equipment within the distribution network. The imaging system 102 may include a scanner configured to detect the campaign barcode on the campaign item. In some embodiments, the imaging system 102 may decode the campaign barcode to retrieve the target address encoded therein. In turn, the sorting equipment may set the campaign item aside for expedited delivery and provide an updated location of the item to the server 104.

The process 200 moves to step 220 where the server 104 identifies the barcode and processes the barcode to extract target address information and/or distribution campaign information. For example, the server 104 may execute a feature extraction algorithm to identify barcodes on different items within the distribution network. The feature extraction algorithm may be pre-trained to identify the intelligent campaign barcode on the campaign item and extract the target address information and campaign information. In some embodiments, the server 104 may receive an image of the intelligent mail barcode from the imaging system 102 or an image of the label. According to some embodiments, the imaging system 102 may be configured to image an item, detect the intelligent campaign barcode, extract the target address information and campaign information, and transmit the target address information and campaign information to the server 104 and/or the user interface 106.

As discussed above, in some embodiments, the imaging system 102 may scan and decode the campaign barcode. The imaging system 102 may provide the decoded information such as the target address and/or a distribution campaign identifier to the server. The imaging system 102 may also provide a location of the item. In turn, the server 104 may instruct the imaging system 102 and/or sorting equipment to set aside the item for expedited delivery. In some embodiments, the imaging system may automatically set aside the item for expedited deliver based on the intelligent campaign barcode. In some embodiments, the server 104 may provide sorting instructions based on the target address, the campaign identifier, and/or the location of the campaign item.

As a campaign item makes its way through the distribution network, the server 104 may provide updates to the user interface 106 about the campaign item. For example, the server 104 may provide an up-to-date location of each campaign item and a projected delivery date and/or delivery time for each item. In some embodiments, the server 104 may passively store the up-to-date location and projected delivery date for each campaign item. The user interface 106 may query the server 104 to retrieve the up-to-date location and projected delivery date for each campaign item. For example, a recipient or a sender may log into the user interface 106 and request the location and projected delivery date for a particular campaign item. In some embodiments, the request may be generated automatically when the recipient or sender access the user interface 106. The user interface 106 may query the server 104 and retrieve the up-to-date location and projected delivery date for the particular campaign item from the server 104.

The process 200 moves to step 222 where the user interface 106 delivers the digital content to a recipient associated with the target address. When a campaign item reaches a delivery facility, the user interface 106 identifies that the campaign item is “out for delivery” and delivers the digital content to the recipient. In some embodiments, the imaging system 102 or the server 104 may identify that the campaign item has reached the delivery facility, and the server 104 may indicate to the user interface 106 that the campaign item is out for delivery. The server 104 may also provide the digital content to the user interface 106 along with the updated status of the campaign item.

The user interface 106 may provide a display or information based on a set of permissions associated with a particular user. The user interface 106 may provide different displays or information regarding the distribution campaign based on whether a particular user is acting as a sender or a recipient of a distribution campaign. For example, when the user interface 106 delivers the digital content, the user interface 106 may provide the digital content, an image of the item, and/or an estimated delivery time or date. Conversely, the sender of a distribution campaign may log into the user interface 106 and view location information, delivery status, campaign interaction metrics, or similar information regarding the distribution campaign in addition to the digital content and images of campaign items. The displays and information provided by the user interface 106 may be determined by a set of permissions associated with a particular user.

The user interface 106 may deliver the digital content to the recipient. The user interface 106 may deliver the digital content to the recipient via an email, push notification in a mobile app or through a browser, a kiosk, or the like. For example, the user interface 106 may deliver the digital content via email to an email address associated with the target address. The email may include the image of the item, a delivery icon, a digital payload, and/or an estimated delivery date and time. In some embodiments, when the recipient selects the delivery icon within the email, the user interface 106 may provide the digital payload. In another example, the user interface 106 may deliver the digital content through an application. The user interface 106 may be formatted to fit a device executing the application, e.g. a mobile device, a kiosk screen, desktop computer monitor, etc. The user interface 106 may generate a push notification through the mobile app that appears on a device belonging to the recipient. When the recipient opens the push notification, the user interface 106 may provide an image of the item, a delivery icon, a digital payload, and/or an estimated delivery date and time to be displayed in the mobile application user interface.

In some embodiments, the user interface 106 may detect a campaign theme and generate an on-screen effect in the mobile application user interface and/or in a separate application or home screen portion of a user's computing device which is running the mobile application. For example, the distribution campaign may be a birthday themed campaign, and the user interface 106 may produce a confetti effect. In some embodiments, the mobile application user interface may be an extension of the user interface 106 where the user interface 106 is formatted to fit a particular device and is personalized based on a user, such as the recipient.

The steps depicted in FIG. 2 illustrate one embodiment of the invention and are not intended to limit the scope of the invention. In some embodiments, the user interface 102 may perform more or fewer steps. In some embodiments, the user interface 102 may perform the steps depicted in FIG. 2 in a different order.

FIG. 3 is a flow diagram depicting a process 300 performed by a user interface such as the user interface 106. The process 300 begins with step 302 where the user interface 106 receives a request to generate a distribution campaign as discussed above in conjunction with FIG. 2. The process 300 moves to step 304 where the user interface 106 receives a request to create digital content associated with the distribution campaign such as a delivery icon or the digital payload. The creator or sender of the distribution campaign may generate the request by selecting an element with the user interface 106 such as a create delivery icon or a create digital payload button. In some embodiments, the request to generate a distribution campaign may include the request to create the digital content such that steps 302 and 304 are a single step.

The process 300 moves to step 306 where the user interface 106 displays a digital content library. The digital content library may be a module within the user interface 106 that allows the sender to browse customizable templates for delivery icons and digital payloads. For example, the digital content library may include one or more delivery icon templates. In some embodiments, the digital content library may display digital coupon templates that may be customized and provided with a distribution campaign. The user interface 106 may retrieve the digital content library from the server 104, where the library and its contents are stored according to some embodiments From time-to-time, new customizable templates may be added or removed from the digital content library. In some embodiments, the digital content library may be customizable by a user. For example, the user may upload or create a new template, delete a template, or rearrange the templates within the digital content library via the user interface 106.

Each of the templates in the digital content library may be pre-formatted to conform with digital content format parameters. Alongside each template in the digital content library, the user interface 106 may indicate how the template may be customized. For example, the user interface 106 may indicate text that may be edited, color schemes that can be used, where graphics may be added, or the like. Advantageously, the digital content library further streamlines the creation of a distribution campaign by providing pre-formatted templates that may be rapidly deployed in a campaign by a sender. By providing the digital content library, distribution campaigns will be employed more frequently. For example, small businesses that do not have the means to hire a graphic designer for a distribution campaign can create a distribution campaign because a barrier to entry has been removed, which in turn improves the speed and efficiency of the distribution network.

In some embodiments, the user interface 106 may automatically display the digital content library and/or the preview label in response to receiving the request to generate a distribution campaign, combining steps 302, 304, and 306. The user interface 106 may also provide an upload module configured to allow the sender to upload digital content to be used in the distribution campaign. In some embodiments, the user interface 106 may allow a user to customize uploaded digital content. The user interface 106 may verify that uploaded digital content conforms with the digital content format parameters as discussed above in conjunction with FIG. 2. In some embodiments, the user interface 106 may provide the digital content templates for download. The sender may download the template, customize it using another application, and reupload the customized template to the user interface 106, which may receive the customized template.

The process 300 moves to step 308 where the user interface 106 receives the selection of digital content. The sender may browse the digital content library to select a digital content template, and the user interface 106 may receive the selection. For example, in some embodiments, a sender may find a template that corresponds with the subject of the distribution campaign and click on the template within the user interface 106 to select the template.

The process 300 moves to step 310 where, in response to receiving the selection of digital content, the user interface 106 provides the selected template in an editing module. The editing module may provide different customization tools to the user such as a text editor, a color scheme editor, a drawing tool, an upload tool, a drag and drop tool, a resize tool, or the like. In embodiments where the sender uploads digital content, the user interface 106 may provide the uploaded content in the editing module. The sender may select a customization tool and make changes to their selected template as they see fit. Some senders may be satisfied with the template “as is” while others may make several changes. For example, the sender may select a delivery icon template from the digital content library, add a logo to the template, resize the logo, change the color scheme, and/or change pre-existing text on the template.

As the sender makes changes, the process 300 moves to step 312 where the user interface 106 receives the customization inputs via the editing module. The editing module may be a part of the user interface 106, and the user interface 106 may directly receive the customization inputs through the editing module. In some embodiments, the editing module may be a separate user interface or application, and the user interface 106 may receive the customizations from the editing module.

The process 300 moves to step 314 where the user interface 106 applies the customization input to the selected template. The user interface 106 applies the customization inputs and updates the template within the editing module to reflect the changes. The user interface 106 may apply the changes in real-time. In some embodiments, the user interface 106 may apply the customizations to the selected template such that the edited template automatically conforms with the digital content format parameters as the sender makes changes to the template. The user interface 106 may detect when a customization input does not conform with the digital content parameters, forego applying the customization input, and notify the sender of the error. In some embodiments, when the sender is finished making changes to the template, the user interface 106 may automatically edit the template such that the customized template complies with the digital content format parameters.

The process 300 moves to step 316 where, the user interface 106 provides the customized template to be used as the digital content associated with the campaign. The user interface 106 may provide the customized digital content once the sender is finished editing the selected template. In some embodiments, the user interface 106 may receive an indication from the sender that they are done customizing the selected template. For example, the sender may click a “done editing” button within the user interface 106 to finish customizing the template. The user interface 106 may provide the customized template as the digital content associated with the distribution campaign. Once the customized template is provided, the template may be referred to as the “customized digital content,” such as the “customized delivery icon” or the “customized digital payload.” For example, the user interface 106 may provide a customized delivery icon template as a custom delivery icon associated with a distribution campaign. The user interface 106 may also provide a customized digital payload such as a custom greeting, animation, or photo album as the digital payload associated with a distribution campaign.

The process 300 moves to step 318 where the user interface 106 receives a request to customize the labels for each of the target addresses. In response to the request, the user interface 106 may provide a preview label that includes a target address, the intelligent campaign barcode, and a label image. The preview label may be provided by the user interface 106 in the editing module. The user interface 106 may provide different label images that may be included beside the target address on the label, such as a birthday cake, a Christmas tree, a menorah, a “no image” option, or similar themed images. The user interface 106 may also provide tools for changing the font or color of the target address on the label.

The process 300 moves to step 320 where the user interface 106 receives a request to generate a campaign theme that includes a request to create the digital content associated with the campaign. Accordingly, the user interface 106 may prompt the sender to select a campaign theme “type” such as birthday, congratulations, holiday, condolences, sale, grand opening, special offer, or the like. After the sender selects a campaign type, the user interface 106 may provide the digital content library with templates that correspond to the campaign theme to expedite selection in the manner described above. The user interface 106 may also provide a preview label to be customized by the sender in the manner described above. The user interface 106 may provide the preview label with a label image that matches the campaign type. For example, if the sender selected birthday as the campaign theme, the user interface 106 may prepopulate the preview label with a birthday cake as the label image.

In some embodiments, the user interface 106 may store the customized digital content, the distribution campaign theme, the labels, the target addresses, the intelligent campaign barcode, the sender's information, and other distribution campaign information. The user interface 106 may store the distribution campaign information locally or it may store the campaign information on the server 104. Further, the user interface 106 may provide the campaign information to the sender in a campaign dashboard. The campaign information may be represented by a campaign icon. The sender may select the campaign icon, and the user interface 106 may provide the campaign information. In some embodiments, the user interface 106 may provide the campaign information within an editing module where the sender may update one or more addresses, update digital content such as the delivery icon or the digital payload, change the campaign theme, and/or edit campaign information. The user interface 106 may update the campaign information to reflect the changes and may provide the updated digital content to a recipient associated with each target address. For example, someone who is getting married may select their “Save the Date” campaign and edit the digital payload to include an RSVP link instead of a photo album. The person may then print the labels and send out the invitations. When the user interface 106 receives an image of the invitation, the user interface 106 may provide the RSVP link as the digital payload.

In some embodiments, the sender may update the campaign based on an interaction with the campaign. The user interface 106 may detect that a recipient has opened or interacted with the digital content associated with the campaign. For example, where a digital coupon is provided as the digital content, the user interface 106 may detect when a recipient opens, downloads, or otherwise saves the coupon. In some embodiments, the user interface 106 may communicate with a point of sale (POS) system and further detect when the recipient uses the coupon. When the sender later updates the campaign, the sender may select a subset of target addresses. The selection of the subset of target addresses may be based on the interaction with the distribution campaign and/or a type of interaction with the distribution campaign. For example, a business owner may send out digital coupons to be used during a grand opening of their new store. The business owner may want to reward their first customers and send out another coupon. Using the user interface 106, the business owner may update their grand opening campaign, select the subset of recipients that used the coupon, and create another digital coupon to send to those recipients. As time passes, the user interface 106 may allow the business owner to identify their most loyal customers who frequently interact with distribution campaigns by providing interaction data for each recipient with multiple distribution campaigns. In some embodiments, the user interface 106 may automatically identify those recipients that more frequently interact with the digital content.

The steps depicted in FIG. 3 illustrate one embodiment of the invention and are not intended to limit the scope of the invention. In some embodiments, the user interface 106 may perform more or fewer steps. In some embodiments, the user interface 106 may perform the steps depicted in FIG. 3 in a different order.

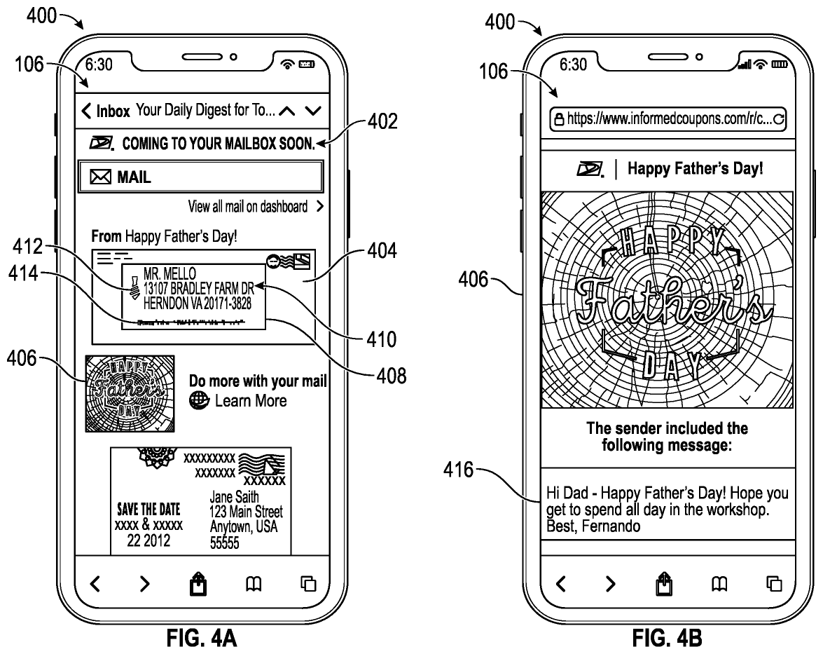

FIG. 4A is an exemplary embodiment illustrating the user interface 106 delivering the digital content associated with a distribution campaign via a display 400. The display 400 is shown as a mobile device display in FIGS. 4A and 4B, but these are exemplary embodiments only. The display 400 may be a monitor, television, smart watch, projector screen, or the like. The user interface 106 may provide the display 400 some or all of the functionalities. As discussed above in conjunction with FIGS. 2 and 3, the user interface 106 may deliver the digital content associated with a distribution campaign to a recipient through the display 400. For example, the user interface 106 may generate a delivery notification email 402 and send the email 402 to an email address associated with the target address. The email 402 may include an image of the item 404 and the delivery icon 406 as shown in FIG. 4A. The email 402 may include images of other items unrelated to the distribution campaign that are being delivered to the recipient along with the campaign item(s). In some embodiments, the server 104 may detect that a campaign item has arrived at a local delivery hub and will be sent out for delivery. Accordingly, the server 104 may deliver the digital content to a recipient. For example, the server 104 may detect that a campaign item is going out for delivery and send the email 402 to the recipient. The user interface 106 may then provide the digital content to the recipient via the display 400 as disclosed herein.

The image of the campaign item 404 may show the label 408 affixed to the campaign item. As discussed above, the label 408 may include the target address 410, a label icon 412, and the intelligent campaign barcode 414. The target address 410, label icon 412, and barcode 414 may be placed in different configurations on the label 408 depending on the relative size of each of the elements or to conform with distribution network parameters. For example, if the intelligent campaign barcode 414 was a 2D barcode, the barcode 414 may be placed on the right-hand side of the label 408. In some embodiments, the target address 410, the label icon 412, and intelligent campaign barcode 414 may be printed on the campaign item 404 in a variety of orientations relative to one another.

The email 402 may also include a delivery icon 406, which may be uploaded, selected, or customized by the sender as discussed above. The delivery icon 406 may be a static object or a dynamic object that the recipient may interact with. In some embodiments, the recipient of the email 402 may select or click on the delivery icon 406, and the user interface 106 may provide the delivery icon 406 and digital payload 416 shown in FIG. 4B.

FIG. 4B illustrates how the user interface 106 may provide the delivery icon 406 and the digital payload 416 via the display 400. As discussed in conjunction with FIG. 4A, the user interface 106 may provide the delivery icon 406 in the body of an email 402. When a recipient selects or clicks on the delivery icon 406 in the email 402, the user interface 106 may provide the delivery icon 406 and the digital payload 416 to the recipient as shown in FIG. 4B. In some embodiments, the user interface 106 may provide the digital payload 416 in the body of the email 402 or as an attachment. For example, the digital payload 416 may be provided in the email 402 alongside the delivery icon 406 in the email 402 shown in FIG. 4A. The digital payload 416 may be a text greeting as shown in FIG. 4B, a picture, an animation, a video, a sound, a hyperlink, or the like.

In some embodiments, the user interface 106 may provide different versions of the digital payload 416 based on the recipient. For example, the user interface 106 may customize the digital content based on the timing or frequency of the recipient's interaction with distribution campaigns. For example, a new store may offer a 50% to the first 100 customers who claim a digital coupon and provide $10 off to everyone else. The user interface 106 may provide the 50% off or the $10 off coupon based on whether the recipient is one of the first 100 customers to claim the coupon.

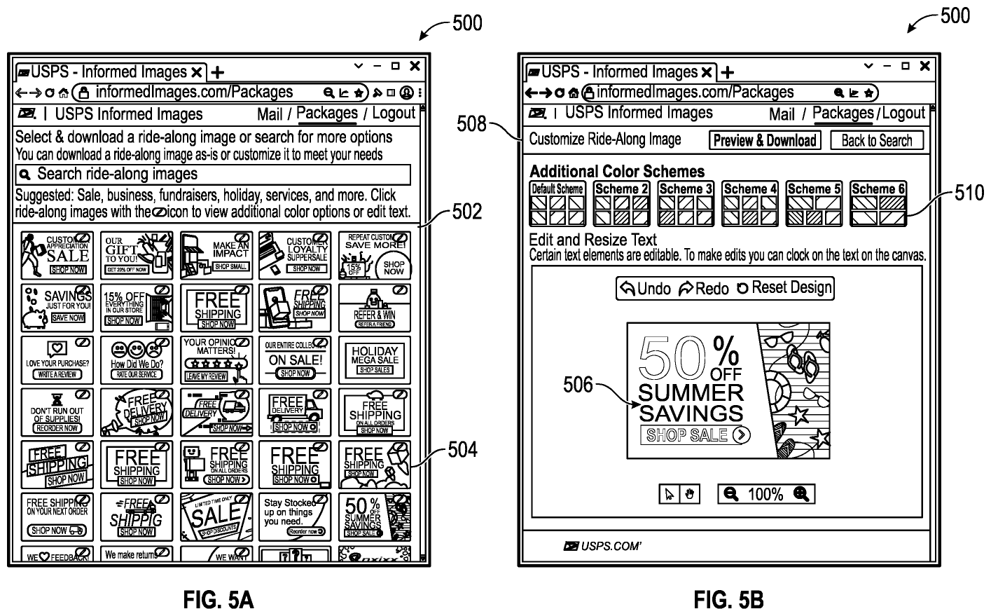

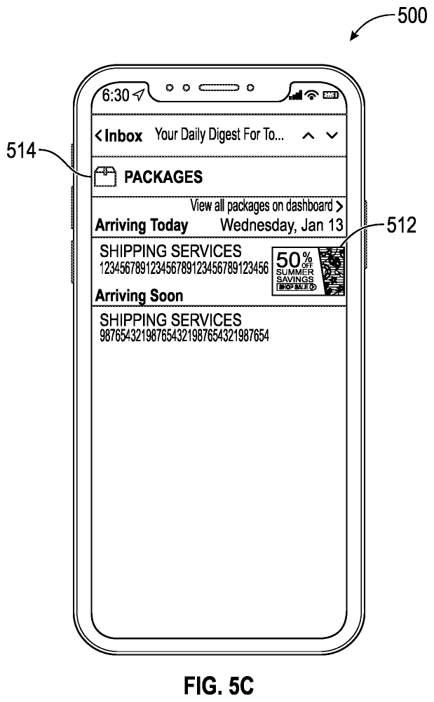

FIG. 5A is an example user interface 500 for selecting a delivery icon template. The user interface 500 may be configured similar to the user interface 106. As previously discussed, the user interface 500 may receive a request to create digital content associated with the distribution campaign, such as a delivery icon. In response to receiving a request to create the delivery icon, the user interface 500 may provide a library of delivery icon templates 502. The library may be browsed by the sender through the user interface 500 until the sender selects a template icon such as the template icon 504. In some embodiments, the user interface 500 may indicate how each template in the delivery icon library 502 may be customized. In some embodiments, the user interface 500 may provide different versions of the same delivery icon template within the delivery icon library 502.

FIG. 5B depicts an exemplary user interface for customizing a selected delivery icon. After the sender has browsed the digital content library and selected a template, the user interface 500 may provide the selected template 506 in an editing module 508. As discussed above, the editing module 508 may include editing tools 510 that the sender may use to customize the template such as a text editor, a color editor, a drag and drop tool, a resizing tool, an upload tool, or the like. The user interface 500 may receive a customization input for the selected template 506. In response, the user interface 500 may apply the customization input to the selected template 506. For example, the sender may select a new color scheme for the selected template 506, and the user interface 500 may change the colors of the selected template 506 within the editing module 508 to reflect the new color scheme. Once the sender is satisfied with the customization of the selected template 506, they may send an indication to the user interface 500 indicating the selected template 506 is ready to be provided with the distribution campaign as a customized delivery icon. After the customized template 506 is provided, the template 506 may be referred to as the “customized delivery icon” 512. In some embodiments, the user interface 500 may provide a preview of the customized delivery icon 506. The user interface 500 may also provide the customized delivery icon 506 for download by the sender. In some embodiments, the user interface 500 may ensure that the customized template 506 complies with digital content format parameters or automatically format the customized selected template 506 to conform with the parameters as discussed above.

FIG. 5C is an example user interface 500 depicting a delivery notification email 512 that includes the customized delivery icon 512. The user interface 500 may associate the customized delivery icon 512 with the distribution campaign and distribute the customized icon 512 in a delivery notification email 514 . The delivery notification email 514 may include an image of the item, the digital payload, delivery information, images of packages that are arriving alongside the item, and other information. As shown in FIG. 5C, the user interface 500 may include the customized delivery icon 512 in the delivery notification email 514. The customized delivery icon 512 may be a static or dynamic object within the email. For example, a recipient may interact with the customized delivery icon 512 to access the digital payload associated with the distribution campaign.

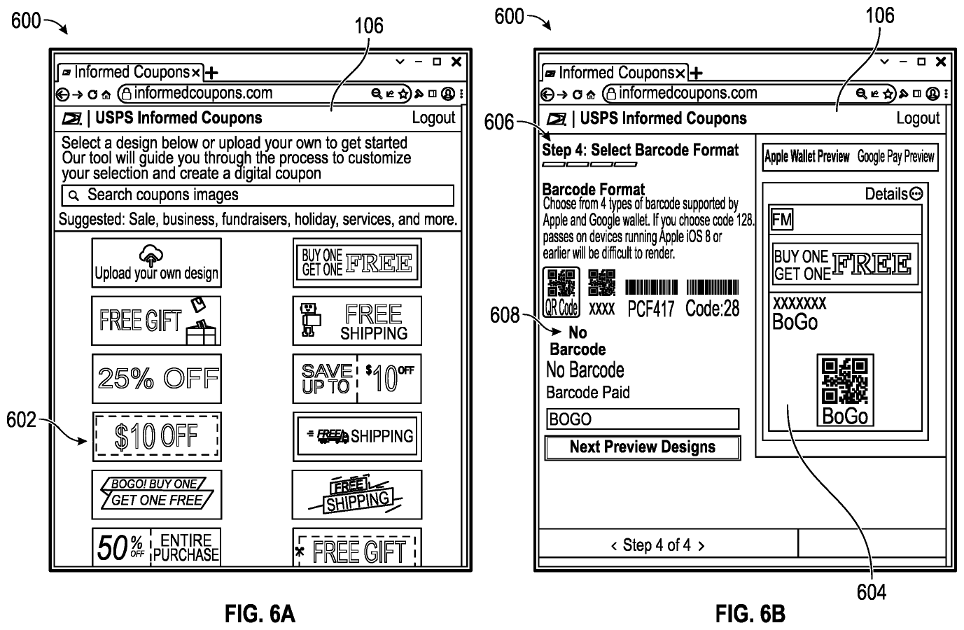

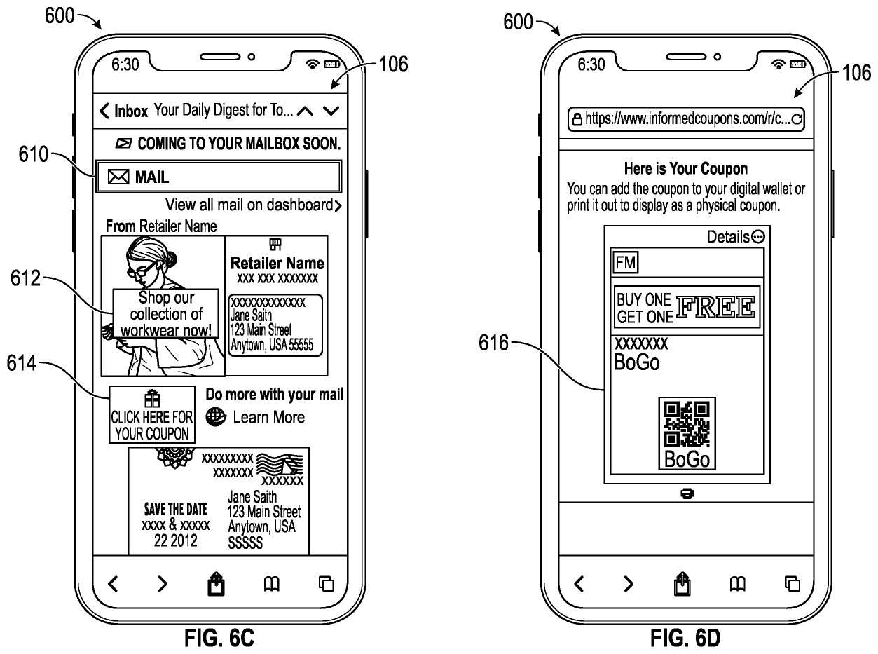

FIG. 6A is an example user interface 106 for selecting a digital coupon template through a display 600. The display 600 is shown as a mobile device display in FIGS. 6A-6D, but these are exemplary embodiments only. The display 600 may be a monitor, television, smart watch, projector screen, or the like. Similar to the user interface 500 discussed in conjunction with FIGS. 5A, 5B, and 5C, the user interface 106 may receive a request from the creator or sender of a distribution campaign to generate or customize a digital coupon to be used as the digital payload for the distribution campaign. In response to receiving the request, the user interface 106 may provide a library of digital coupon templates 602 for the sender to browse and select from via the display 600. In some embodiments, the user interface 106 may indicate how each coupon template within the library 602 may be customized. The sender may select a digital coupon template from the library, and the user interface 106 may receive the selection.

FIG. 6B depicts the user interface 106 providing a selected digital coupon template 604 for customization via the display 600. Once the sender selects a digital coupon template from the template library 602, the user interface 106 may provide the selected digital coupon template 604 in an editing module 606 as shown in FIG. 6B. As discussed above, the editing module 606 may provide tools for the sender to customize the digital coupon template, such as changing the barcode format, changing the text on the coupon, changing the color scheme, adding or removing shapes, images or logos, or similar functions. For example, the sender may want to add their business logo or add an expiration date to the digital coupon 604. In some embodiments, the user interface 106 may provide a barcode selection tool 608 that enables a sender to select a barcode format for the digital coupon such as a linear barcode or a two-dimensional matrix barcode.

The sender may select the barcode format based on a type of point-of-sale (POS) system they employ. For example, the sender's POS system may only read a linear barcode, and the sender may select the linear barcode using the barcode selection tool 608. In some embodiments, the sender may need to enter the digital coupon into their POS system. For example, the sender may need to scan the digital coupon and select the discount to be applied by the POS system. In some embodiments, the user interface 106 may be paired to or placed in communication with the POS system and may automatically upload the digital coupon information. For example, the user interface 106 may provide for interconnectivity between the user interface 106 and different POS systems that may be employed by a sender.

Additionally, the user interface 106 may receive other customization inputs such as a text edit, color scheme change, or additional or removal of graphic elements. The user interface 106 may receive the customization inputs and may apply them to the selected coupon template 604 within the editing module 606. In some embodiments, the user interface 106 may provide previews of different formats that may be applied to the digital coupon template 604 based on the type of device that opens it. For example, the user interface 106 may provide an Android device mobile coupon preview, an Apple device mobile coupon preview, and/or a web browser coupon preview. When the sender is satisfied with how the digital coupon template 604 looks, the user interface 106 may provide the customized version of the selected coupon template 604 as the digital payload for the distribution campaign. Once the customized template 604 is provided, the template 604 may be referred to as customized digital payload 616 or customized digital coupon 616. In some embodiments, the user interface 106 may receive an indication from the sender that customization is complete, and in response to the indication from the sender, the user interface 106 may provide the customized template 604 as the digital payload.

FIG. 6C illustrates a delivery notification email 610 delivered by the user interface 106. As discussed above, the delivery notification email 610 may include an image of the item 612 and a delivery icon 614. The delivery icon 614 may be a static or dynamic object. For example, the delivery icon 614 may be a dynamic object. When the recipient of the delivery notification email 610 selects or clicks on the delivery icon, the user interface 106 may detect the type of device executing the user interface 106 and provide the digital coupon 616 in a compatible format based on a device type and/or a device operating system. For example, the user interface 106 may be executed by an Android device comprising the display 600. When a recipient selects the delivery icon 614, the user interface 106 may detect the device type and provide the customized digital coupon 616 in an Android-compatible format.

FIG. 6D depicts the user interface 106 providing the customized digital coupon 616. In some embodiments, the user interface 106 may provide the customized digital coupon 616 after a recipient selects the delivery icon 614 within the delivery notification email 610 as discussed above. In some embodiments, the user interface 106 may also provide the customized digital coupon 616 in the delivery notification email 610. In some embodiments, the user interface 106 may provide the customized digital coupon 616 based on a type of device that the customized digital coupon 616 is to be displayed on. For example, the user interface 106 may detect that the customized digital coupon 616 is to be displayed on an Android device and may provide the customized digital coupon 616 in an Android-compatible format.

The present disclosure refers to processor-implemented steps for processing information in the system. Instructions can be implemented in software, firmware or hardware and include any type of programmed step undertaken by components of the system. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The central hub 120 may comprise a processor such as, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom, A-series, or FX processor, or the like. The processor 111 typically has conventional address lines, conventional data lines, and one or more conventional control lines.

The system may be used in connection with various operating systems such as Linux®, UNIX®, MacOS®, or Microsoft Windows®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

Those of skill will further recognize that the various illustrative logical blocks, modules, circuits, and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Memory Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer- readable medium, which may be incorporated into a computer program product.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it covers all modifications and alternatives coming within the true scope and spirit of the invention as embodied in the attached claims.

What is claimed is:

1. A system for distributing items, the system comprising:
an imaging device configured to capture an image of one or more campaign distribution items; and
one or more processors in communication with the imaging device, the one or more processors configured to:
receive a request to generate the distribution campaign;
receive one or more target addresses;
receive a digital content associated with the distribution campaign;
generate an intelligent campaign barcode associated with the distribution campaign for each of the one or more target addresses;
cause generation of a physical indicator for each of the one or more target addresses to be affixed to the one or more campaign distribution items, wherein the physical indicator includes the intelligent campaign barcode associated with the distribution campaign;
receive the image of the one or more campaign distribution items;
detect the intelligent campaign barcode on the physical indicator affixed to the one or more campaign distribution items; and
deliver the digital content to an email address associated with the one or more target addresses based on the intelligent campaign barcode.

2. The system of claim 1, wherein the digital content comprises a delivery icon and a digital payload accessible through the delivery icon.

3. The system of claim 2, wherein the digital payload is one of: a text greeting, an image file, a video file, a sound, a digital coupon, a hyperlink.

4. The system of claim 2, further comprising item processing equipment in communication with the one or more processors, and wherein the item processing equipment is configured to affix the generated physical indicator to the one or more campaign distribution items.

5. The system of claim 2, wherein the one or more processors are further configured to:
receive a request to generate the delivery icon associated with the distribution campaign;
display a library of digital content;
receive a selection of digital content from the library of digital content; and
provide the selected digital content as the delivery icon associated with the distribution campaign.

6. The system of claim 4, wherein digital content in the digital content library conforms with digital content parameters.

7. The system of claim 4, wherein the one or more processors are further configured to:
provide the selected digital content in an editing module;
receive at least one customization input via the editing module, wherein the at least one customization input changes the appearance of the selected digital content;
apply the customization input to the selected digital content; and
provide the selected digital content as the delivery icon associated with the distribution campaign.

8. The system of claim 2, wherein the one or more processors are further configured to:
receive a request to generate a digital coupon;
display a library of digital coupon templates;
receive a selection of an electronic coupon template; and
provide the selected coupon template as the digital payload associated with the distribution campaign.

9. The system of claim 8, wherein the one or more processors are further configured to:
provide the selected coupon template in an editing module;
receive at least one customization input via the editing module, wherein the at least one customization input changes the appearance of the selected coupon template;
apply the customization input to the selected coupon template; and
provide the selected coupon template as the delivery icon associated with the distribution campaign.

10. The system of claim 8, wherein the electronic coupon includes a barcode.

11. The system of claim 1, wherein the request to generate the distribution campaign comprises a distribution campaign theme.

12. The system of claim 11, wherein the one or more processors are further configured to:
generate a label icon on the physical indicator based on the distribution campaign theme.

13. The system of claim 1, wherein the one or more processors are further configured to:
provide the one or more target addresses to a mailing API, the mailing API configured to identify a verified mailing address for each of the one or more target addresses and generate a list of verified mailing addresses;
receive the list of verified mailing addresses from the mailing API; and
generate the physical indicator for each of the one or more target addresses using the list of verified mailing addresses.

14. The system of claim 1, wherein the one or more processors are further configured to:
identify a verified mailing address for each of the one or more target addresses;
generate a list of verified mailing addresses; and
generate the physical indicator for each of the one or more target addresses using the list of verified mailing addresses.

15. The system of claim 14, wherein the one or more processors are further configured to:
display a prompt to replace the one or more target addresses with the list of verified mailing addresses;
receive a confirmation to replace the one or more target addresses with the list of verified mailing addresses; and
generate the physical indicator for each of the one or more target addresses using the list of verified mailing addresses.

16. The system of claim 1 further comprising a printer in communication with the one or more processors, wherein the printer is configured to print the physical indicator for each of the one or more target addresses.

17. The system of claim 1, wherein the one or more processors are further configured to:
provide a delivery status of the distribution campaign to a sender, wherein the delivery status indicates whether the one or more campaign distribution items are: in transit, out for delivery, or delivered.

18. The system of claim 1, wherein the one or more processors are further configured to:
store the distribution campaign, a delivery icon, a digital payload, the one or more target addresses, and the intelligent campaign barcode.

19. The system of claim 18, wherein the one or more processors are further configured to:
display a previous campaign dashboard, wherein the previous campaign dashboard includes a campaign icon representing the distribution campaign.

20. The system of claim 19, wherein the one or more processors are further configured to:
receive a selection of the campaign icon in the previous campaign dashboard;
provide the distribution campaign, the delivery icon, the digital payload, the one or more target addresses for editing;
receive an update to one or more of: the distribution campaign, the delivery icon, the digital payload, the one or more target addresses; and
generate the physical indicator for each of the one or more target addresses based on the update.
